(19) United States
(12) Patent Application Publication
(10) Pub. No.: US 2024/0330902 A1
(43) Pub. Date: Oct. 3, 2024

(54) SYSTEMS AND METHODS FOR GENERATING GRAPHICS FOR CRYPTOGRAPHIC TOKENS

(71) Applicant: PUMA SE, Herzogenaurach (DE)

(72) Inventor: Ivan Dashkov, Boston, MA (US)

(21) Appl. No.: 18/612,664

(22) Filed: Mar. 21, 2024

Related U.S. Application Data
(60) Provisional application No. 63/454,775, filed on Mar. 27, 2023.

(51) Int. Cl. G06Q 20/36; G06T 11/00

(52) U.S. Cl. CPC G06Q 20/367; G06T 11/00

(57) ABSTRACT

A method of generating graphics for digital assets includes receiving an input identifying a first digital wallet. One or more non-fungible tokens associated with the first digital wallet are identified, and at least one non-fungible token is selected from the one or more non-fungible tokens, each token of the selected at least one non-fungible token being associated with a corresponding digital asset including at least one attribute. A graphic is generated based on the at least one attribute of the digital assets corresponding to each of the selected at least one non-fungible token. The graphic is provided to a virtual environment and displayed within the virtual environment.

### CROSS-REFERENCE TO RELATED APPLICATIONS

This application claims the benefit of and priority to U.S. Provisional Application No. 63/454,775, filed on Mar. 27, 2023, which is incorporated by reference herein in its entirety.

### BACKGROUND

Non-fungible tokens can represent products or digital assets with properties that can be integrated into applications and systems connected to a blockchain. Graphics can be generated for tokens and digital assets associated therewith, and the graphics can be used or displayed in virtual environments. Graphics may be context specific and can be generated based on information from multiple tokens, from contextual information, and from parameters specific to a virtual environment.

Thus, there is a need to provide systems and methods for generating graphics associated with tokens (including fungible and/or non-fungible tokens) for display within virtual environments.

### SUMMARY

In accordance with some embodiments of the disclosed subject matter, systems, methods, and media using cryptographic tokens, e.g., non-fungible tokens, are provided.

In one aspect, a method of generating graphics for digital assets includes receiving an input identifying a first digital wallet. One or more non-fungible tokens associated with the first digital wallet are identified, and at least one non-fungible token is selected from the one or more non-fungible tokens, each token of the at least one non-fungible tokens being associated with a corresponding digital asset including at least one attribute. A graphic is generated based on the at least one attribute of the digital assets corresponding to each of the selected non-fungible tokens. The graphic is provided to a virtual environment and displayed within the virtual environment.

In another aspect, a method of generating non-fungible tokens includes retrieving, from a first blockchain, a first token and a second token associated with a first digital wallet, the first token being associated with a first digital asset defining a first attribute and the second token being associated with a second digital asset defining a second attribute. The first and second tokens are provided to a smart contract. A third token and a third digital asset associated with the third token are generated by the first smart contract based at least on the first attribute and the second attribute. A graphic is generated based on the at least one display attribute and is displayed within a first virtual environment.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 depicts an example of a system for generating a non-fungible token in accordance with some embodiments of the disclosed subject matter;

FIG. 2 depicts an example of hardware that can be used to implement a computing device and a server in accordance with some embodiments of the disclosed subject matter;

FIG. 3 depicts a schematic representation of an example blockchain network according to some embodiments of the present disclosure;

FIG. 4 depicts another schematic representation of an example blockchain network according to some embodiments of the present disclosure;

FIG. 5 depicts a flowchart for an example method of generating a digital asset protected by a non-fungible token according to some embodiments of the present disclosure;

FIG. 6 depicts a schematic representation of a NFT and associated digital asset;

FIG. 7 depicts a flowchart for an example method of generating a graphic for one or more tokens in a wallet of a user;

FIG. 8 depicts a schematic representation of an embodiment of a system for generating graphics associated with cryptographic tokens and rendering the graphics within a virtual environment; and

FIG. 9 depicts a schematic representation of a breeding process for breeding a virtual item NFT with a brand NFT, according to some embodiments.

### DETAILED DESCRIPTION

The present application includes embodiments of mechanisms (e.g., systems, methods, and media) for generating digital assets secured by cryptographic tokens, e.g., non-fungible tokens (NFTs), and which correspond to physical objects (e.g., articles of apparel, or articles of footwear), or which correspond to a set of entitlements to digital systems, or which correspond to benefits which can be provided by a manufacturer or retailer, or which correspond to virtual objects in a video game or metaverse. In some embodiments, this disclosure relates to cryptographic digital assets for articles, objects, or transactions. For example, cryptographic digital assets can be associated with, inter alia, tangible objects, including sports shoes, eyewear, apparel, headgear, or sporting gear, among other products, such as, e.g., watches, luggage, jewelry, storage or shipping containers, artwork, mobile phones or smartphones, tablets, televisions or other electronic devices, refrigerators or other appliances, and vehicles or other machines, or the articles or objects may be intangible objects, including graphic designs, virtual avatars or characters, graphic user interfaces, or other forms of communication.

Further, this disclosure relates to cryptographic digital assets that can be updated based on user activities and transactions, and methods for provisioning of such cryptographic digital assets and articles, and decentralized computing systems with attendant blockchain control logic for mining, exchanging, collaborating, modifying, combining, and/or blending blockchain-enabled digital assets and articles. The presently described technology relies on the trust established in and by blockchain technology to enable a company to control the creation, distribution, expression, and use of digital objects that represent their brand. Unlike typical digital assets that are freely reproducible without loss of content or quality, the use of discrete recordation of ownership via blockchain technology establishes an ownership of the digital asset, which may provide the owner of the NFT with certain rights, benefits, and entitlements that can be associated with ownership of the digital asset. The manufacturer of the NFT and the associated digital asset has the ability to control or limit the overall supply of the digital objects or traits/aspects thereof and may create a controlled scarcity if so desired. The present disclosure contemplates that, in some examples, the digital object may be representative of: a physical object offered for sale; a 2D or 3D design rendering or design file that may be suitable for future production; a virtual representation of an object that is not presently intended for physical creation/production; a proof of attendance at an event, or entitlement to attend an event; a representation of a user's interactions or transactions with a manufacturer or retailer; or other such objects. Further, some embodiments of the present disclosure include mechanisms for generating cryptographic tokens using virtual reality (VR), augmented reality (AR), and/or graphical user interfaces (GUIs) on computing devices.

In some embodiments, NFTs can secure, authenticate, or verify ownership of digital assets having different properties and different functions. A uniform resource identifier (URI) of an NFT can be a uniform resource locator (URL) pointing to a digital asset, or metadata associated with a digital asset that is hosted on a server of a host system. The metadata of a digital asset can further include a URL where the digital asset is hosted remotely, off-chain or off of the blockchain. For example, accessing a URI of a sustainability NFT can include accessing the URI in a browser, and visually inspecting the attributes, which may be presented in a code-readable format (e.g., JSON, XML, HTML, etc.). A URI of a digital asset representing sustainability attributes of a transaction may return a list of the sustainability attributes, which could, in turn, be utilized by third party platforms (e.g., video game systems and digital marketplaces) to provide the owner of the digital asset some functionality or benefit.

In some embodiments, an NFT can function as a digital identity for an owner, and can provide access to digital markets, gateways, portals, APIs, games, or web pages which the owner would not otherwise be able to access. For example, an NFT can entitle the owner to access a webpage for a vendor that could provide the owner with access to exclusive benefits. In some embodiments, the benefits offered could be based on the type and metadata of an NFT.

As used herein, a “digital asset” refers to digital files or data for which ownership can be assigned. A digital asset could be a text document, an image file, a video, an audio file, a database file, code blocks, a database, an encryption key, or anything that can be represented digitally, and can be accessed at an addressable location. Further, the digital asset may be a digital-art version of a tangible, physical object or place, or an object disassociated with tangible, physical objects. The digital asset can include metadata which can describe aspects of the digital asset, functions, or properties of the digital asset, and can be formatted in a computer-readable format (e.g., json, xml, yml, html, etc.). A “cryptographic digital asset,” as used herein, is a digital asset secured by (e.g., associated with) an NFT minted to a blockchain, or one that has a unique, non-fungible tokenized code (“token”) registered on and validated by a blockchain platform or otherwise registered in an immutable database, thus cryptographically securing an interest in the digital asset to the owner of the NFT. An interest can, but need not be, an ownership interest in the cryptographic digital asset, a copyright thereof, a right to use the cryptographic digital asset in a third-party application, or any other interest which can be associated with the cryptographic digital asset.

A “smart contract” is an agreement that is in the form of a self-enforcing software program that runs on the blockchain network, so it is distributed across a blockchain network and is itself immutable. The terms within a smart contract, such as one in an NFT, are dictated by one or more of the parties. When creating a smart contract, a party or multiple parties may include programming to allow for negotiation, modification, full or partial acceptance, full or partial refusal, and, ultimately, full or partial enforcement or waiver. It will be appreciated that, as used herein, consideration is merely something of value given in exchange from one party to the other and may be real or personal property, such as, e.g., currency, or may be a return promise, an act, or forbearance. Additionally, options are contracts in which an offeree gives consideration for a promise by the offer or not to revoke an outstanding offer, and options can be provided as part of a larger contract or, alternatively, the option may be the foundation of the contract itself. A smart contract in an NFT may, but need not, be legally enforceable. The code of a smart contract can include functions for reading from or writing to the smart contract. For example, a smart contract can include a function that returns information about a digital asset, or a function returning information about an owner of a digital asset. Additionally or alternatively, a function of a smart contract could be called (e.g., code of the function could be executed) by an owner of the contract to distribute funds exchanged in the execution of the smart contract.

As used herein, the term “cryptographic token” is a digital value that is stored/recorded on a blockchain. Cryptographic tokens include payment tokens, such as coins (e.g., Bitcoin), utility tokens, security tokens, and “non-fungible tokens.” As used herein, “non-fungible token” (“NFT”) refers to a cryptoasset in the form of a unique, cryptographic token corresponding to a digital asset, which can include any of the examples of a digital asset listed above. The NFT may be a blockchain-based deed of digital ownership and/or certificate of authenticity of a digital asset. As used herein, an NFT is not a digital asset, but is used to signify ownership of the digital asset. The NFT can be built (i.e., minted) in accordance with contemporary and relevant standards, such as, e.g., an Ethereum Request for Comments (ERC) 721 (Non-Fungible Token Standard) or ERC1155 (Multi Token Standard) among other relevant standards and as appropriate for the particular blockchain network and applications used therewith. Further, an NFT is built or minted in accordance with the terms of a smart contract. The particular conditions and terms of a smart contract can govern details of a transaction involving the minting or transfer of an NFT, and the terms can impact the value or, at least, the perceived value of the NFT over time. For example, a smart contract can enforce a rarity of NFTs minted under the smart contract by limiting the maximum allowable number of NFTs which can be minted under the contract. In some cases, a smart contract can include terms mandating that a royalty be paid to the owner of the smart contract upon a secondary sale of an NFT. In essence, the NFT represents authentication of the transaction and serves as a record of this authentication on a blockchain ledger (e.g., Bitcoin, Ethereum, and the like). As such, the NFT itself may fluctuate in value depending on various aspects of the transaction, e.g., the parties involved, value exchanged, time and/or date, exclusivity, or combinations thereof, among other factors. Further, the number and/or frequency of transactions may also cause the NFT to fluctuate in value.

A digital asset can be accessible at a web address (i.e., the URI) that is referenced in the non-fungible token securing it. The web address can be a link which, when accessed, can serve the digital asset, or could serve information or metadata of the digital asset. Because of a cost associated with storing information in a non-fungible token, the token itself may contain only enough information to identify the digital asset and prove ownership, with the rest of the information about the digital asset residing on computer systems that are not themselves nodes in the blockchain. Accessing the web address can return a list of properties of the digital asset to the user through a graphical user interface, or, alternatively, in a format that is consumable by computer programs and applications that may access the digital asset. For example, the web address could return information about the digital asset in JSON format or XML format, and the address of the digital asset itself could be included in the list of properties. A digital asset representing a transaction could thus have properties specifying the time of the transaction, a selling party, information about products purchased, sustainability attributes of products and of the transaction, etc. In some cases, an address referenced in a non-fungible token could be an API endpoint that may vary information returned to the user, or implement a function based on the HTTP method through which the API endpoint is accessed. The API endpoint could allow a user or system to perform a GET, HEAD, PUT, or POST, for example, which could allow a digital property of the digital asset to be changed based on the operation performed. The GET and HEAD operations can be read-only operations and can provide publicly available information about the digital asset without the need for authentication. Access to the write operations (e.g., POST, PUT) of the API endpoint referenced in an NFT can require authentication, and could thus only be accessible to the manufacturer of the NFT and digital asset, for example.

A “Uniform Resource Identifier” or “URI” is a unique sequence of characters that identifies a logical or physical resource used by web technologies. URIs may be used to identify any resource, including non-virtual objects, such as locations or people, or digital information resources, such as web pages. The URI can comprise a “Uniform Resource Name” (“URN”) or a “Uniform Resource Locator” (“URL”).

NFTs can be created, recorded, or “minted” into the blockchain ledger stored in the blockchain network, and thereby stored in memory of one or more of the blockchain nodes. Further, such cryptographic tokens can be destroyed or “burned” by permanent removal from circulation in the blockchain network. Burning can be accomplished in a variety of ways, including by transferring ownership of the cryptographic token to a general, null address that is inaccessible and unowned. Manufacturers, also referred to herein as brands or organizations, may burn cryptographic tokens to create scarcity within the marketplace, or to trigger a condition, or as a result of a condition, or for security purposes. For example, a brand may release, e.g., “drop,” a collection of digital assets secured or identified by cryptographic tokens, and then may burn any unsold cryptographic tokens within the collection to preserve exclusivity of those sold. In another example, a brand may drop a collection of digital assets secured or identified by NFTs with the condition that purchasers may only have access to their purchased digital asset when all or a particular quantity of the collection has been purchased, which may be expedited by the brand then burning unsold NFTs to meet the condition prematurely.

There are several ways a user can be enabled to unlock or acquire a cryptographic asset. In one example, upon scanning a product at a point-of-sale (POS) terminal during first purchase, a unique NFT and corresponding private key are automatically generated and assigned to the user's blockchain wallet. In another example, a private key is provided to the user via a printed or digital receipt, a visual or electronic ID tag (RFID or NFC) hidden in or applied to the product, a pop-up message or email sent to a personal user account, a push notification or text message sent to a smartphone, or some other record; the consumer uses the private key to link the cryptographic asset to their digital blockchain wallet. Another example may require the user to assemble the private key in part via a physical code or Unique Product Identifier (UPID), e.g., a serial number, associated with the product (on the packaging or box, on a hang tag, under a label, embedded within a QR code on the product or packaging, embedded within a shoe or sole, etc.) and in part via a transaction authentication code (i.e., to prevent a consumer from collecting a cryptographic asset while merely handling products in a store). As another example, an NFT could be offered for sale directly in an NFT marketplace, directly at a POS system, or on a digital storefront of a retailer or manufacturer.

Another example may require the user to “seek” cryptographic assets in stores, whether physical stores or virtual stores inside a metaverse or game, by using a photographic capture function or augmented reality (“AR”) function on a handheld personal computing device. For this method, a private key may be provided via the validated transaction, however, the user must separately find a hidden cryptographic asset in an AR hidden within the store or local area before the digital asset can be transferred to their wallet (i.e., the cryptographic key and the virtual object must both be separately acquired before the transfer occurs).

In a representative example, an authenticated product is created and assigned a UPID. Upon purchase by a consumer, the UPID may be used to unlock a cryptographic digital asset composed of a sustainability digital asset associated with a unique non-fungible token (NFT) on a block-chain based distributed computing platform. In general, a consumer must have or procure a blockchain wallet address (e.g., an Ethereum hardware wallet) to purchase, unlock, or acquire an NFT securing a cryptographic digital asset. The blockchain wallet may be used to store a private key belonging to the cryptographic digital asset and may be linked to a personal account that is registered with the retailer or manufacturer of the product.

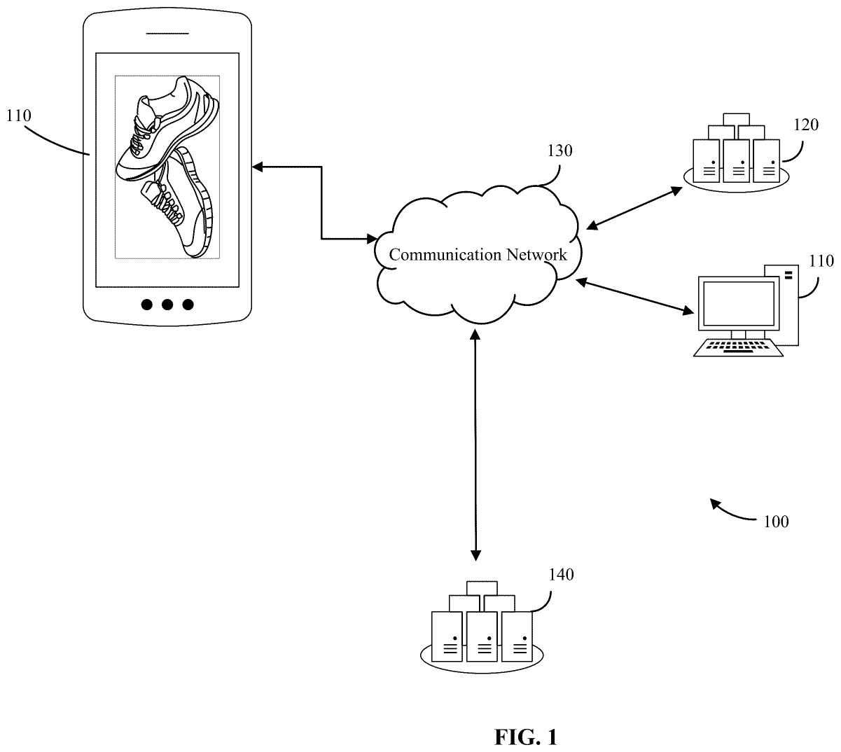

FIG. 1 illustrates an example system 100 for generating an NFT in accordance with some embodiments of the disclosed subject matter. In other embodiments of the disclosed invention, however, a system similar to system 100 could be used to generate other types of NFTs, including, for example, account NFTs. As shown in FIG. 1, the system 100 may include one or more computing devices or user devices 110, one or more servers 120, one or more communications networks 130, and one or more servers 140.

Still referring to FIG. 1, the one or more computing devices 110 can receive data corresponding to one or more products. Additionally, or alternatively, the one or more computing devices 110 can receive input data from a user that correspond to attributes of one or more digital products. The one or more computing devices 110 can execute at least a portion of the system 100 to generate one or more NFTs corresponding to a transaction including the one or more products. Additionally, or alternatively, the one or more computing devices 110 can communicate data corresponding to the one or more products to one or more servers 120 and/or one or more servers 140 over the one or more communication networks 130, or over one or more wired connections.

The one or more servers 120 can execute at least a portion of the system 100. In such embodiments, the one or more servers 120 can receive data corresponding to one or more products. Additionally, or alternatively, the one or more servers 120 can receive input from a user that corresponds to attributes of one or more products. The one or more servers 120 can execute at least a portion of the system 100 to generate one or more NFTs corresponding to the one or more products. Further, information about digital assets secured by one or more NFTs can be stored on servers 140.

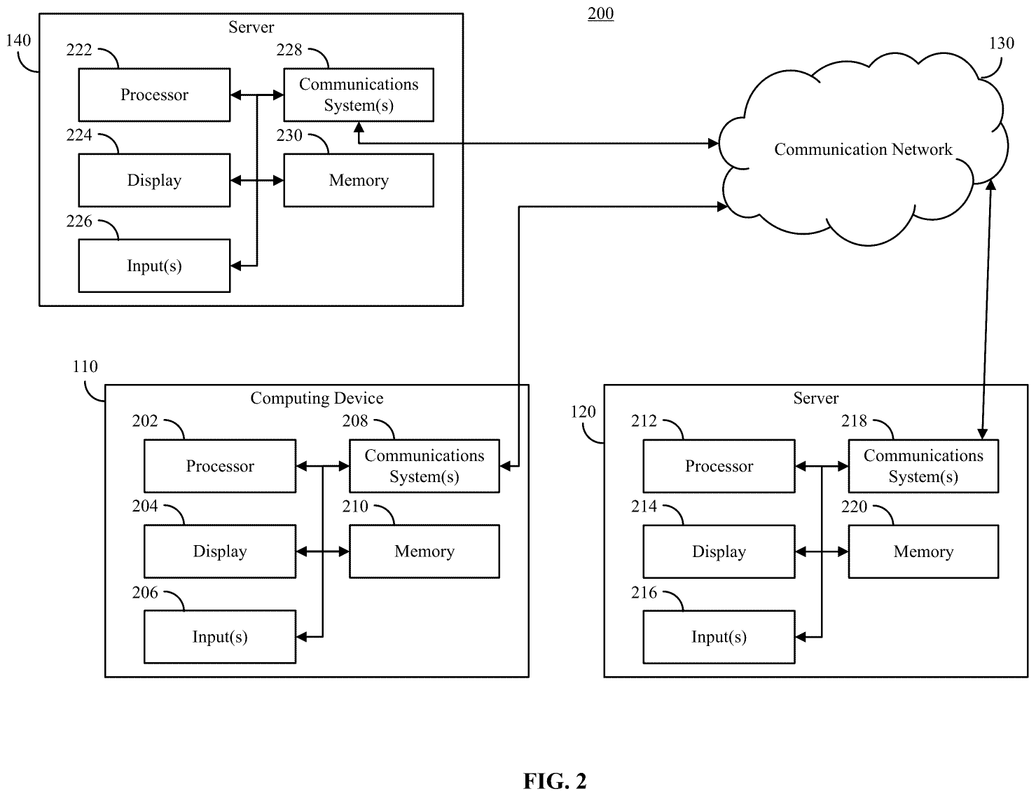

FIG. 2 shows an example of hardware 200 that can be used to implement the computing device 110 and/or server 120 in accordance with some embodiments of the disclosed subject matter. As shown in FIG. 2, in some embodiments, the computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In some embodiments, the display 204 can include any suitable display device, such as a computer monitor, a touchscreen, a television, etc. In some embodiments, the inputs 206 can include any suitable input devices and/or sensors that can be used to receive user input, such as a keyboard, a mouse, a touchscreen, a microphone, a camera, etc.

In some embodiments, the communication systems 208 can include any suitable hardware, firmware, and/or software for communicating information over the communication network 130 and/or any other suitable communication networks. For example, the communication systems 208 can include one or more transceivers, one or more communication chips and/or chip sets, etc. In a more particular example, the communication systems 208 can include hardware, firmware and/or software that can be used to establish a Wi-Fi connection, a Bluetooth connection, a cellular connection, an Ethernet connection, etc.

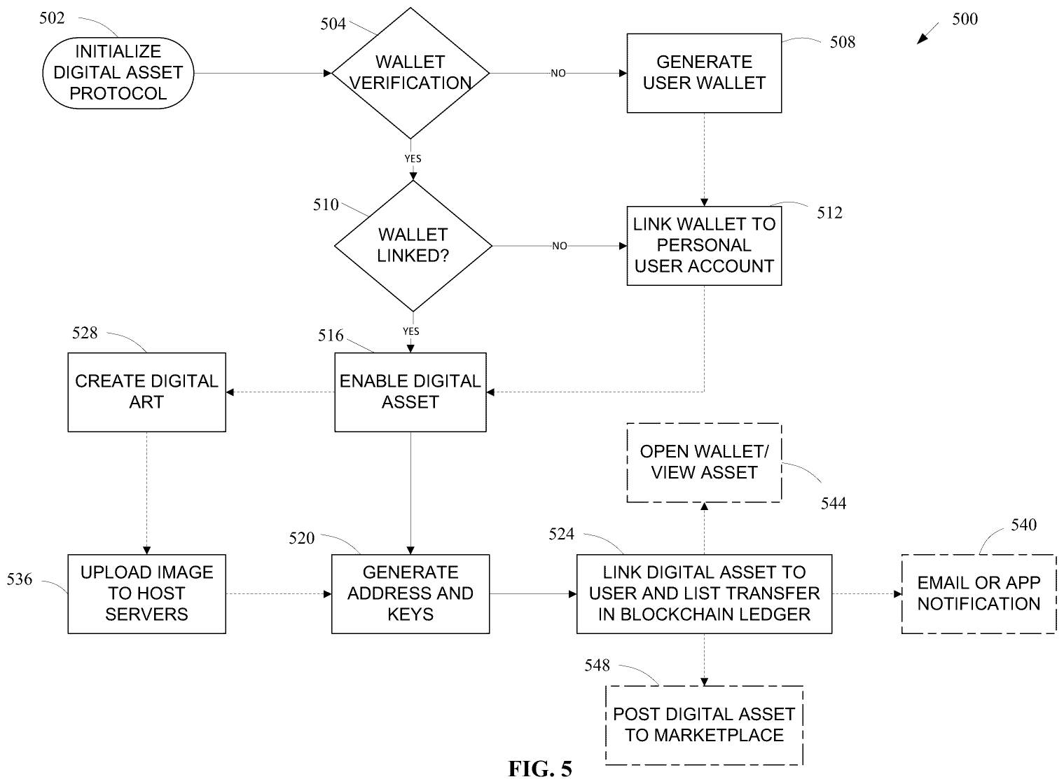

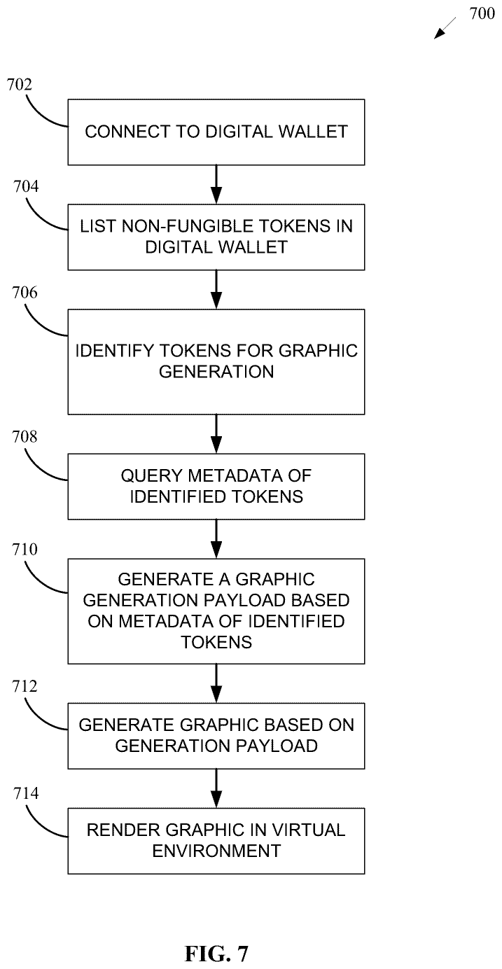

In some embodiments, memory 210 can include any suitable storage device or devices that can be used to store instructions, values, data, etc., that can be used, for example, by the processor 202 to generate a non-fungible token, to present a digital asset using the display 204, to communicate with the server 120 via the communication systems 208, etc. The memory 210 can include any suitable volatile memory, non-volatile memory, storage, or any suitable combination thereof. For example, the memory 210 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 210 can have encoded thereon a computer program for controlling operation of the computing device 110. In some examples, the processor 202 can execute at least a portion of processes 500 and 700 described below in connection with FIGS. 5 and 7.

In some embodiments, the server 120 can include a processor 212, a display 214, one or more inputs 216, one or more communication systems 218, and/or memory 220. In some embodiments, the processor 212 can be any suitable hardware processor or combination of processors, such as a CPU, a GPU, an ASIC, an FPGA, etc. In some embodiments, the display 214 can include any suitable display device, such as a computer monitor, a touchscreen, a television, etc. In some embodiments, the inputs 216 can include any suitable input devices and/or sensors that can be used to receive user input, such as a keyboard, a mouse, a touchscreen, a microphone, a camera, etc.

In some embodiments, the communication systems 218 can include any suitable hardware, firmware, and/or software for communicating information over the communication network 130 and/or any other suitable communication networks. For example, the communication systems 208 can include one or more transceivers, one or more communication chips and/or chip sets, etc. In a more particular example, the communication systems 218 can include hardware, firmware and/or software that can be used to establish a Wi-Fi connection, a Bluetooth connection, a cellular connection, an Ethernet connection, etc.

In some embodiments, the memory 220 can include any suitable storage device or devices that can be used to store instructions, values, data, etc., that can be used, for example, by the processor 212 to present content using the display 214 to communicate with the one or more computing devices 110. The memory 220 can include any suitable volatile memory, non-volatile memory, storage, or any suitable combination thereof. For example, the memory 220 can include RAM, ROM, EEPROM, one or more flash drives, one or more hard disks, one or more solid state drives, one or more optical drives, etc. In some embodiments, the memory 220 can have encoded thereon a server program for controlling operation of the server 120. As another example, the processor 212 can execute at least a portion of the server program, which can be a smart contract, to implement the system 100 for generating an NFT corresponding to a product or transaction. As an example, the processor 202 can execute at least a portion of processes 500 and 700 described below in connection with FIGS. 5 and 7.

In some embodiments, the server 140 can include a processor 222, a display 224, one or more inputs 226, one or more communication systems 228, and/or memory 230. In some embodiments, the processor 222 can be any suitable hardware processor or combination of processors, such as a CPU, a GPU, an ASIC, an FPGA, etc. In some embodiments, the display 224 can include any suitable display device, such as a computer monitor, a touchscreen, a television, etc. In some embodiments, the inputs 226 can include any suitable input devices and/or sensors that can be used to receive user input, such as a keyboard, a mouse, a touchscreen, a microphone, a camera, etc.

In some embodiments, the communication systems 228 can include any suitable hardware, firmware, and/or software for communicating information over the communication network 130 and/or any other suitable communication networks. For example, the communication systems 228 can include one or more transceivers, one or more communication chips and/or chip sets, etc. In a more particular example, the communication systems 228 can include hardware, firmware and/or software that can be used to establish a Wi-Fi connection, a Bluetooth connection, a cellular connection, an Ethernet connection, etc.

In some embodiments, the memory 230 can include any suitable storage device or devices that can be used to store instructions, values, data, etc., that can be used, for example, by the processor 222 to present content using the display 224, to communicate with the one or more computing devices 110. The memory 230 can include any suitable volatile memory, non-volatile memory, storage, or any suitable combination thereof. For example, the memory 230 can include RAM, ROM, EEPROM, one or more flash drives, one or more hard disks, one or more solid state drives, one or more optical drives, etc. In some embodiments, the memory 230 can have encoded thereon a server program for controlling operation of the server 140. As an example, the processor 222 can execute at least a portion of process 500 and 700 described below in connection with FIGS. 5 and 7.

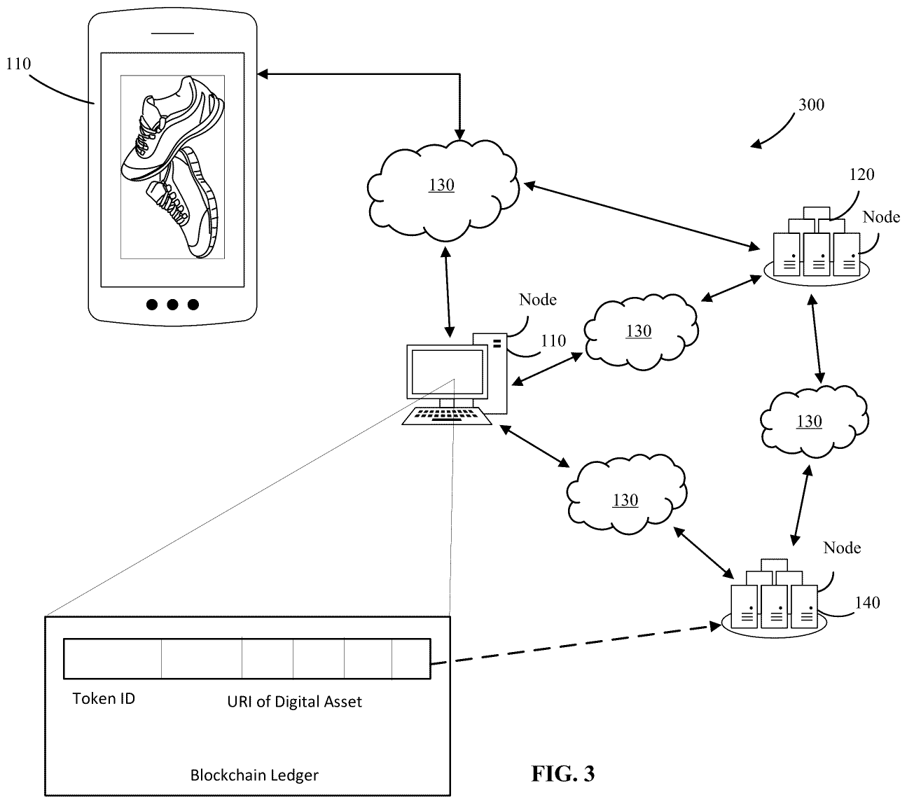

FIG. 3 illustrates an example blockchain network 300 according to some embodiments of the present disclosure. The blockchain network 300 may include one or more blockchain nodes. The blockchain nodes may each be the computing device 110 or the server 120 that are in communication with one another (e.g., via a communication network similar to the communication network 130 of FIGS. 1 and 2). The NFT may be stored in a blockchain ledger stored on one or more of the blockchain nodes (e.g., “minted” into the blockchain ledger stored in the blockchain network, and thereby stored in memory of one or more of the blockchain nodes). For example, attributes of the NFT may be stored in memory (e.g., memory 210) on a local computing device (e.g., computing device 110), and may be copied into the memory (e.g., memory 220, 230) of one or more blockchain nodes, e.g., servers, such as the server 120, and/or computing devices that may be similar to the computing device 110. The one or more blockchain nodes may be responsible for storing data that is contained in the blockchain ledger. Each of the one or more blockchain nodes may store (e.g., in memory, such as the memory 210 or 220 or 230) a copy of the blockchain ledger, e.g., a deed tracking various transactions of, and modifications to, an NFT securing a digital asset, such as a sustainability digital asset.

The information of an NFT stored in the blockchain may be minimal, as there may be a cost associated with storing information on the blockchain. Therefore, metadata of the digital asset, and the digital asset itself can be stored in a memory (e.g., memory 230) or storage of the one or more servers 140. A URI can be stored with the NFT on the nodes 110, 120, and can include an address of the digital asset stored on the one or more servers 140, so that information about the digital asset can be obtained from the URI stored in the NFT, and the users of the blockchain network do not pay a disproportionate price for storing digital assets on the blockchain network.

The one or more blockchain nodes may each be a computing device located at one or more geographic locations, thereby creating a decentralized computing architecture. The blockchain network may be a public network (e.g., available to any user), or a private network (e.g., available to a specific set of users). For example, an organization may develop an application for storing NFTs corresponding to transactions of physical and/or digital products, e.g., sports shoes, electronics, watches, eyewear, headgear, sports equipment, or articles of apparel. The application may be a mobile application, or desktop application, or a web-based applet, comprising computer-readable instructions stored in, for example, memory 210 or 220, and configured to be executed by, for example, the processor 202 or 212 (see FIG. 2). Any user who downloads the application onto a computing device may then add their computing device to the blockchain network as a blockchain node. In some embodiments, the blockchain network may be private and, thus, limited to users who download the organization's application and obtain authorization to participate. If the application is available to the public, then the blockchain network may be a public network. However, if the organization restricts who has access to the application or restricts authorization for select individuals who download the application from becoming a blockchain node, then the blockchain network may be a private network, such as e.g., a permissioned network. Generally speaking, the permissioned network is a distributed ledger that is not publicly accessible and can only be accessed by users with certain permissions, and the users can only perform specific actions granted to them by the central owner or the ledger administrators and are required to identify themselves through certificates or other digital means. In some embodiments, the blockchain network may be a known blockchain network (e.g., Ethereum, Solana, Tezos, Flow, or the like), and the permissioned network may be a sub-set or service associated with a known blockchain network.

The blockchain network may be an open, yet encrypted peer-to-peer network in which asset transaction records are linked via cryptographic hash functions in a distributed, immutable ledger of interconnected blocks. Each blockchain node may contain a ledger of blocks that includes one or more digital asset transactions accompanied by corroboration information representing a validity of each transaction as assessed by peer-validation devices, e.g., the other blockchain nodes in the blockchain network. Encrypted, decentralized computing architectures allow for authentication of transacted assets while preventing duplication of ownership of a cryptography-protected (“cryptographic”) digital asset registered to the blockchain network. Decentralized asset management may work by encrypting a proprietary asset file, breaking the encrypted code into segments, and sending the segments to numerous different blockchain nodes (e.g., the blockchain nodes of FIG. 3) in the blockchain network. A validated owner may be provided with a private key that indicates where in the network the digital asset is located and how to reassemble or “decrypt” the file. For use as a distributed ledger, an individual blockchain may be managed by a host administrator and distributed to multiple peers collectively adhering to a protocol for inter-node communication and transaction validation.

An NFT (e.g., an NFT associated with a digital asset including information to be used for rendering graphics in a virtual environment) may be stored in the blockchain network. The NFT may include, or may reference metadata corresponding to display attributes for displaying a graphic in a virtual environment, and a token ID. The token ID may be a 32-bit, 64-bit, or 128-bit alphanumeric code that is sectioned into individual segments. For example, the alphanumeric code may be sectioned into 2 segments, 4 segments, 8 segments, 16 segments, or 32 segments. The NFT can include a URI specifying a location where metadata of the digital asset can be located. The metadata provided at the web address specified can include a list of attributes of the digital asset in JSON format that is provided in accordance with contemporary and relevant standards, such as, e.g., an Ethereum Request for Comments (ERC) 721 (Non-Fungible Token Standard) or ERC1155 (Multi Token Standard), among other relevant standards and as appropriate for the particular blockchain network and applications used therewith. This metadata can be stored on the one or more servers 140, which can be controlled by the manufacturer or the retailer.

For example, using the example of an NFT for displaying graphics, the metadata provided at the URI address specified in the NFT and hosted on servers 140 can correspond to one or more attributes from the group of: a color, an item to be displayed, a size of the item, a retailer of the item, a brand, a logo, a functionality of the item (e.g., a visual response to interactions), etc. Additional combinations of the above-listed attributes should be recognized by those of ordinary skill in the art.

One should appreciate that the disclosed systems and techniques provide many advantageous technical effects including construction and storage of a digital asset blockchain representing user-to-user transactions of virtual collectables. Further, the blockchain technology enables the creation of unique, yet fully transferrable digital assets that maintain value by way of the general inability to make lossless copies, unlike traditional, unsecured digital files.

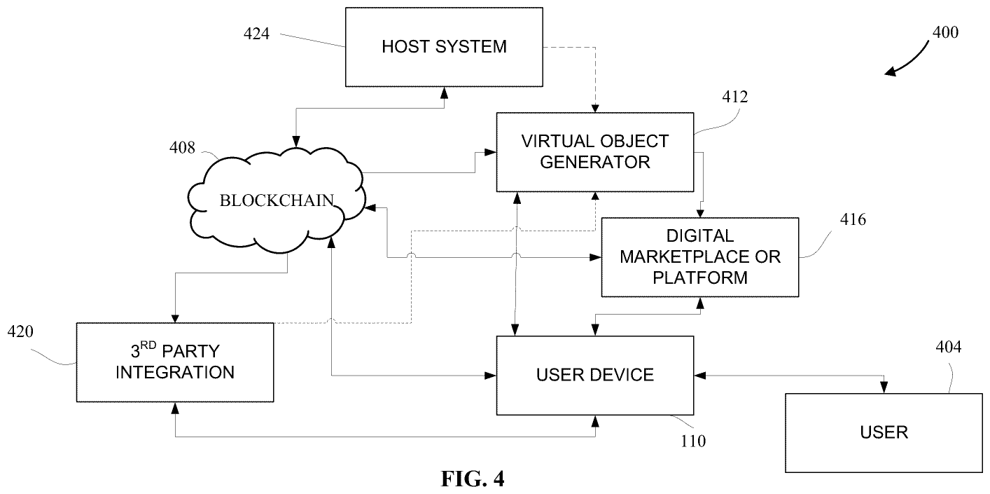

FIG. 4 provides a schematic representation of a functional structure of a decentralized computing system or blockchain network 400, similar to the blockchain network 300 of FIG. 3. As generally illustrated, a user 404 may operatively interface with the user device 110 that may include one or more of a smartphone, a tablet computer, a smart watch, a laptop computer, a desktop computer, a standalone video game console, smart footwear/apparel, or other similar internet enabled devices, e.g., a television, an exercise machine or device, or a vehicle, among other examples. The user device 110 may be operatively configured to communicate with one or more of an immutable public database (e.g., a blockchain service/network 408-referred to as “blockchain network 408”), a virtual object generator 412, an online digital marketplace or platform 416, and/or a third (3^{rd}) party integration service 420.

In general, the blockchain network 408 may include at least one NFT registered thereon that includes or references information representative of a digital asset. The user 404, via the user device 110, may be in possession of or may have a wallet that includes a private cryptographic key that permits the user device to read the encrypted data associated with the NFT. This key may further enable the user 404 to freely transfer ownership of the NFT.

A virtual object generator 412 may be provided to create a digital object or a digital asset on the basis of the information associated with the token. The virtual object generator 412 may employ a plurality of style and artistic rules such that images associated with the resultant digital objects are unique, yet recognizable according to predefined silhouettes, styles, articles, or characters. In some embodiments, the virtual object generator 412 may create the virtual object on the basis of auxiliary factors, such as the age of the asset, user activity (tracked via the user device), or use via third party platform. The virtual object generator 412 and/or blockchain network 408 may further be in communication with a hosted digital marketplace 416, forum, social platform, or the like. The digital marketplace may represent a plurality of virtual objects in a manner that permits the organized trade and/or sale/purchase of the virtual objects between parties. Upon closing of the sale or transfer, the digital marketplace 416 may update the blockchain network 408 with the new ownership information and facilitate the transfer of new or existing keys to the new asset holder. In some embodiments, the marketplace 416 may further enable various social engagement functions, such as voting or commenting on the represented virtual objects. Likewise, in some instances the marketplace 416 may be configured to assess and score the scarcity of a particular virtual object based on the sum total of the object's expressed features or characteristics, as well as consideration of any of the auxiliary factors. Such a scarcity score may then enable the marketplace (and/or users who participate within the marketplace) to better assess the value of the object.

Further, the system 400 may further include a 3rd party integration service 420 that may enable the use of the virtual object in different contexts or manners. The 3rd party integration service 420 may operate as an application programing interface (API) on an app provided on the user's device, or as a dedicated cloud-based service. In some embodiments, the 3rd party integration service 420 may make the virtual object (e.g., as expressed by the virtual object generator 412) and/or the information available for external use. Examples of such a use may include skins on 3rd party video game characters, objects capable of being used by 3rd party video game characters, digital artwork displays, physical 2D print generation, manufacturing production, such as, e.g., 3D print generation, and the like. In one embodiment, the information and/or scarcity score may be made available and may alter the characteristics or abilities of a user's video game character in a video game played on the user's device 110.

A corporate host system 424 may be in communication with the blockchain network 408 for the purpose of provisioning and/or initially creating new digital assets and storing or updating metadata associated with the assets. Additionally, the host system 424 may provide one or more rules to the virtual object generator 412 to constrain the manner and style in which genomic information from the blockchain network 408 is expressed in a visual/artistic form.

With reference to FIG. 5, a method of generating a digital asset protected by NFTs on a blockchain ledger is generally described in accordance with aspects of the present disclosure. Some or all of the operations in FIG. 5 and described in further detail below may be representative of an algorithm that corresponds to processor-executable instructions that may be stored, for example, in main or auxiliary remote memory, and executed, for example, by a resident or remote controller, central processing unit (CPU), control logic circuit, or other module or device or network of devices, to perform any or all of the above or below described functions associated with the disclosed concepts. It should be recognized that the order of execution of the illustrated operation blocks may be changed, additional blocks may be added, and some of the blocks described may be modified, combined, or eliminated.

The method 500 of FIG. 5 starts at terminal block 502 with processor-executable instructions for a programmable controller or control module or similarly suitable processor to call up an initialization procedure for a protocol to generate a cryptographic digital asset. This routine may be called-up and executed in real-time, continuously, systematically, sporadically, and/or at regular intervals. As a representative implementation of the methodology set forth in FIG. 5, the initialization procedure at block 502 may automatically commence each time a user, e.g., the user 404, purchases a product or performs a transaction from a retailer. Alternatively, the initialization procedure may be manually activated by an employee at a POS terminal or by the retailer.

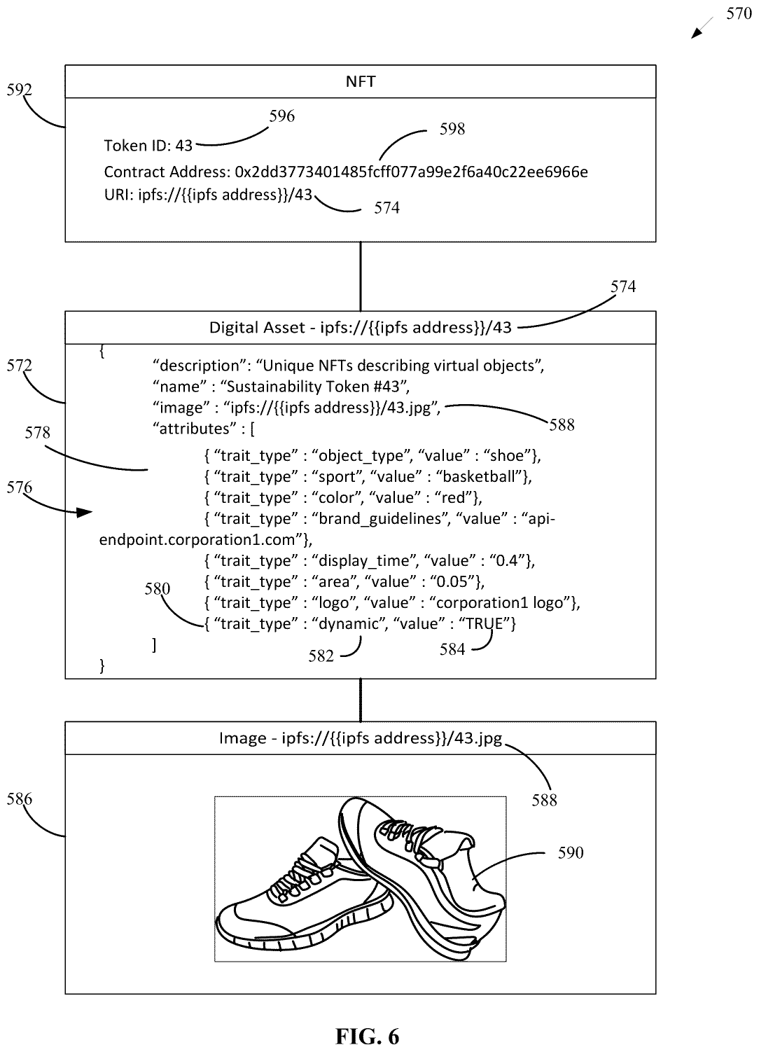

Other initialization procedures may be initiated for different digital assets, which may represent assets other than physical products. For example, a digital asset could represent a proof of attendance at a given event. Accordingly, the digital asset could be spawned upon a confirmation of attendance at an event. Alternatively, a limited number of proof of attendance NFTs may be minted for an event, and those NFTs may be earned by attendees on a first-come first-serve basis, or attendees could earn the remaining NFTs by scanning a QR code, for example. Digital assets can correspond to utility NFTs, which can provide a functionality to the owner. For example, a digital asset can entitle the owner to access to benefits or exclusive content, e.g., as discussed further below and with respect to FIG. 6.

Using a user device 110, such as, e.g., a portable electronic device, including a smartphone, or other electronic device, the user 404 may launch a dedicated mobile software application (app) or web-based applet that collaborates with a server-class (backend or middleware) computer (e.g., a remote host system) to communicate with the various peer devices on the decentralized computing system 400. During a communication session with, e.g., the host system 424, the user 404 may purchase a sports shoe using a corresponding feature provisioned by the app. The user 404 enters personal information and a method of payment to complete the transaction. Upon completion of a validated payment, the host system 424 receives, e.g., from an online store transaction module or an approved third-party electronic payment system, a transaction confirmation to indicate a validated transfer of the sports shoe to the user 404 has been completed. As indicated above, validated transfer of the sports shoe may be effectuated through any available means, including at a brick-and-mortar store, through an online auction website, an aftermarket consumer-to-consumer trade/sale, etc. In other embodiments, the user 404 may perform other transactions, or purchase other products (e.g., apparel, backpacks, hats, watches, sports equipment, footwear, eyewear, etc.). In some embodiments, the user 404 may purchase a digital asset represented by an NFT directly.

Next, the method 500 proceeds to decision block 504 to determine if the user 404 has procured a cryptocurrency wallet or other similarly suitable digital blockchain account that is operable, for example, to upload and maintain location and retrieval information for digital assets that are encrypted and stored in a decentralized manner. A cryptocurrency wallet typically stores public and private key pairs but does not store the cryptocurrency itself; the cryptocurrency is decentrally stored and maintained in a publicly available blockchain ledger. With the stored keys, the owner may digitally sign a transaction and write it to the blockchain ledger. A platform-dictated smart contract associated with the wallet may facilitate transfer of stored assets and create a verifiable audit trail of the same. If the user 404 has not already acquired a digital blockchain wallet, the method 500 continues to predefined process block 508 to set up a wallet. By way of non-limiting example, user 404 may be prompted to visit or may be automatically routed to any of an assortment of publicly available websites that offer a hardware wallet for cold storage of cryptocurrency such as an ERC20-compatible Ethereum wallet provided by MyEtherWallet, or Metamask, among other viable sources or providers.

Once the system confirms that the user 404 has a suitable digital blockchain wallet at process block 504, the method 500 may check if the wallet is linked to a personal user account at decision block 510. In some instances, the user 404 may have already linked a wallet to a user account in a prior transaction, and thus, the method 500 could proceed to process block 516. Where the user 404 has not linked their wallet, the method 500 may automatically link, or prompt the user 404 to link, the digital blockchain wallet to a personal user account, as portrayed at process block 512 of FIG. 5. This linking at process block 512 may proceed automatically if a wallet was generated at process block 508, without the need to perform a check at decision block 510 of whether the wallet has been linked. Linking a wallet to a personal account at process block 512 may require the remote host system 424 to retrieve a unique owner ID code associated with the purchasing party (e.g., user 404) from an encrypted relational database, e.g., provisioned through communication network 130, which may employ a cloud computing system.

Upon determining that the user 404 has acquired a digital blockchain wallet, i.e., block 504=YES, and that the wallet is linked to a personal user account, i.e., block 510=YES, or after linking the user's blockchain wallet to their personal user account at block 512, the method 500 continues to input/output block 516 to enable a sustainability cryptographic digital asset. As indicated above, upon purchasing a product, the universally recognized UPID product code may be used to retrieve sustainability information of the product (e.g., from a relational database, digital assets associated with the product, etc.), which may further be used to generate a digital asset and a corresponding sustainability NFT. A third-party or a retailer at a POS terminal or the user 404 employing their user device 110 may scan the UPID or UPC on the product. Accordingly, enabling a cryptographic digital asset, at block 516, may be automatic, random, systematic, prize based, or by any logically appropriate manner.

After receiving confirmation that a cryptographic digital asset has been authorized at input/output block 516, the method 500 generates a cryptographic digital asset for the transacted product or products. This may comprise generating a unique, encrypted asset code with a contract address (i.e., the address where the smart contract is deployed on the blockchain network), a token, and a public and private key pair, as denoted at predefined process block 520. Host system 424 may transmit the token, with the public key and the owner ID, to a distributed blockchain ledger to record and peer-validate transfer of the cryptographic digital asset to the user 404 on a transaction block. Host system 424 can also store the metadata of the digital asset, and/or the digital asset itself, which can be accessed via the address provided in the NFT. The method 500 continues to process block 524 to link the cryptographic digital asset with the unique owner ID code. This control logic may comprise executable instructions for assigning the encrypted asset code to the user 404 and storing the public and private keys in the user's digital blockchain wallet.

As shown in FIG. 5, once the digital asset has been linked to a user, as through transfer to the user of the NFT securing the digital asset, optional process block 540 may issue a digital notification, such as an email or push notification, to the user's smartphone 110, or other electronic device, with all related information for accessing, transferring, and intermingling the cryptographic digital asset. Additionally or alternatively, the remote host system 424 may operate as a web server hosting a web-based graphical user interface (GUI) that is operable to translate the data stored in the encryption keys into a visual image that is displayed to the user 404 at optional process block 544. Digital asset manipulation and use may also be effectuated through the user's digital blockchain wallet. This may comprise posting the cryptographic digital asset to an online crypto-collectable marketplace or platform, as provided in optional process block 548.

With continued reference to FIG. 5, in some embodiments, after a digital asset is enabled or initialized at block 516, the method 500 can proceed to process block 528 to produce a visual representation or “digital art” of the cryptographic digital asset. The visual representation may include a computer-generated image that is generated based on attributes of the digital asset. It is also envisioned that one or more attributes of the virtual representation of the cryptographic digital asset may be created, in whole or in part, via the user 404. Alternatively, a machine learning function may be executed to generate image features through a neural network to produce the digital art at process block 528. Upon completion of the digital art, the image may be uploaded to host servers 140 at block 536, and the digital art can be included as part of the digital asset.

An NFT according to the present disclosure can be minted with immutable characteristics that cannot be updated by the issuing entity (e.g., using a globally distributed storage such as the Interplanetary File System). Alternatively, a consumer can purchase a single NFT for which attributes of the digital asset associated with the NFT can be updated dynamically in response to an action or an event. In some embodiments, virtual environments can render graphics associated with a user based on attributes of one or more NFTs associated with the user. In some embodiments, a user (e.g., a consumer) may combine (e.g., burn) separate NFTs to generate a new NFT with a digital asset having display attributes or other attributes that are based on the combined attributes of the digital assets of the combined NFTs.

Digital assets for NFTs can include images that are generated to represent the attributes of the NFT. In some embodiments, a digital asset for an NFT does not include images (e.g., does not include a pointer or reference to an image) but the attributes of the digital asset are interpretable by one or more virtual environments to display a graphic within the one or more virtual environments based on the attributes. For example, one attribute can determine a color of a portion of a graphic in a virtual environment associated with the NFT, and another attribute can determine a visual element. The graphic (e.g., the image) can be auto generated based on the attributes of the digital asset. In some embodiments, the graphic can be generated based on combined attributes of more than one digital assets associated with corresponding NFTs owned by a consumer. A consumer can display the graphics (e.g., the images) associated with their NFTs in an online gallery or in the metaverse or can use them in an interactive virtual environment (e.g., as a virtual shoe in a video game). As described above, a consumer can have multiple NFTs, each associated with a digital asset including different display attributes.

Individuals, consumers, and companies can purchase NFTs from other owners to obtain desired display attributes for generation of graphics in virtual environments. In some cases, NFTs can represent licensing agreements or sponsorship agreements conferring an entitlement or an obligation to display a logo or other branding of a company within a virtual environment.

Display attributes of individual digital assets associated with an NFT, or cumulative attributes for NFTs in a consumer's wallet, can be consumed by applications or companies and can be used as input into an online application or workflow (e.g., a video game, the metaverse, online storefronts, online communities, etc.).

FIG. 6 illustrates an exemplary data structure 570 for a digital asset, according to some embodiments of the present disclosure, including a digital asset 572. The digital asset 572 can have an address 574 at which the digital asset can be accessed. For example, the address 574 illustrated is an InterPlanetary File System (“IPFS”) address, and the digital asset 572 is thus immutable and distributed across globally-redundant storage hosted by a third party. In some embodiments, however, an address (e.g., URL or URI) can be any web address that can be resolved by a DNS or is accessible via a web browser. The digital asset can include a json object 576, which can comprise multiple elements (e.g., a description element, a name element, etc.) in accordance with standards for digital assets associated with NFTs. The json object 576 includes an attributes clement 578, which as illustrated comprises an array of dictionaries 580, each defining an attribute 582 for the digital asset 572 and an associated value 584. In some cases, the value for the attribute 582 can be a number. Some attributes 582, however, can be assigned a non-numerical value, which can include a Boolean (e.g., true or false) value or an alphanumerical value. In some embodiments, a virtual object type can be included in the attributes 582 of the digital asset 572. For example, in the illustrated embodiment, the attributes 582 include an attribute “object type” and the value is “shoe.” In some embodiments, the attributes 582 of the digital asset can be attributes of a logo NFT, as described below. For example, a “display time” attribute can include a ratio indicating an amount of time (e.g., as a proportion of a total display time) to display branded content (e.g., 0.4 as shown). Further, attributes 582 can include web addresses. For example, in the illustrated embodiment, a “brand guidelines” attribute includes an api endpoint for a brands guideline api of a given corporation, which can be used to provide information relevant to generation of graphics associated with the digital asset 572. Attributes 582 for a digital object can include any other attributes, including the attributes described for the NFTs below. Further, the NFT and digital asset 572 are not shown to represent a particular NFT described below but are provided to illustrate how attributes 582 can be associated with any digital asset and cryptographic tokens described herein.

In some embodiments, the digital asset 572 can include or reference a digital image object 586. The digital image object 586 can be accessed at a web address 588, which can be included in the digital asset 572 as an element thereof (e.g., the “image” element). The digital image object 586 can include a digital image 590. The digital image 590 can be generated based on the attributes (e.g., attributes 582) of the digital asset. The digital image 590 can be algorithmically generated according to an artificial intelligence model, and attributes 582 of the digital asset 572 can be inputs to the model and can control visual elements of the digital image 590. In other embodiments, all digital images associated with digital assets in accordance with this disclosure can be identical. In other embodiments, digital assets can be generated without associated digital images.

With continued reference to FIG. 6, the exemplary data structure 570 includes an NFT 592 having an example token ID 596 and an example contract address 598. The token ID 596 shown is a simplified example but may be a 32-bit, 64-bit, or 128-bit alphanumeric code that is sectioned into individual segments. In some instances, the alphanumeric code may be sectioned into 2 segments, 4 segments, 8 segments, 16 segments, or 32 segments. The contract address 598 is the address where the smart contract is deployed on the blockchain network, e.g., blockchain network 300 or 408.

Referring now to FIG. 7, an exemplary process 700 for rendering graphics within a virtual environment based on cryptographic tokens is shown. At block 702, a system can connect to a digital wallet of a user. The system can include a graphics generation system which generates a graphic based on cryptographic tokens in a wallet of a user. The graphics generation system can be a microservice that outputs the graphic to other consuming services. For example, a social media platform can be integrated with an API of a graphics generation system to receive a graphic therefrom and display the graphic in conjunction with the user. In some embodiments, a virtual environment, such as a video game, a metaverse, an augmented or extended reality environment, a website, etc. can be operatively connected to the graphics generation system to receive graphics generated by the graphics generation system based on cryptographic tokens in a user's digital wallet. In some embodiments, a graphics generation system can be a module within a given virtual environment. Connecting the wallet to the graphics generation system can include or can be similar to performing blocks 502-510 of the process 500, as illustrated and described in FIG. 5. Linking a wallet can be initiated by a user by interacting with the graphics generation system (e.g., directly or through the virtual environment) and providing authentication information for the wallet. A user may be denied access to use a graphics generator system to generate a graphic based on one or more cryptographic tokens until the user provides authenticating information proving ownership of the wallet to which the cryptographic tokens are linked (e.g., the wallet including the cryptographic secret keys for the respective cryptographic tokens).

At block 704, the graphics generation system can list the cryptographic tokens in the user's wallet. In some embodiments, listing cryptographic tokens in a wallet can include listing only cryptographic tokens meeting certain criteria (e.g., cryptographic tokens of a clothing type, a logo type, or tokens with digital assets including metadata including certain attributes, etc.). Listing the cryptographic tokens in a user's wallet can include storing information retrieved from a blockchain on which the cryptographic tokens reside in a memory of a computer (e.g., a computer that is included in the graphic generation system). In some embodiments, only information of a subset of the cryptographic tokens in a user's wallet is stored in the memory of the computer. In some embodiments, listing the cryptographic tokens can also include retrieving metadata from the digital asset associated with the cryptographic token. In some embodiments, the cryptographic tokens for which information is retrieved can be fungible and/or non-fungible tokens.

At block 706, the tokens to be used for graphic generation can be selected. For example, the graphics generator may only generate a graphic for a first non-fungible token representing a shirt and a second non-fungible token representing a logo. Other examples of tokens that can be used in a graphics generation system can be a cryptographic token representing a certain color scheme and a cryptographic token representing a car to which the color scheme is to be applied. In some embodiments, the cryptographic tokens to be input into the graphics generator system to generate a graphic can be selected automatically based on attributes of the tokens and a context. For example, the graphics generator system can be a system for a sports video game in which the user controls an avatar wearing a sneaker. The graphics generator can determine which cryptographic tokens are compatible with the given virtual environment (e.g., the sports video game) and can render graphics based on the attributes of the tokens, For example, if the sports video game is a basketball video game, and the listed cryptographic tokens in the user's wallet include a basketball shoe NFT, and a boat shoe NFT, and the user's wallet further includes a sports brand NFT (e.g., a NFT representing a logo of a sports brand) and an automotive brand NFT, the graphics generator can determine that the basketball shoe NFT and the sports brand NFT are compatible with the sports video game, and can automatically select those cryptographic tokens to generate a graphic. In some cases, there can be multiple cryptographic tokens in a user's wallet that are compatible with a given virtual environment, and process 700 could provide the user a prompt at block 706 to select which of the compatible NFTs to be used to generate a graphic. In some embodiments, a user can select which cryptographic tokens to input into the graphics generator system to produce a desired graphic within a virtual environment.

At block 708, metadata for the identified cryptographic tokens can be queried. The metadata can be used to define the asset to be generated. For example, in some embodiments, a shoe NFT can have a “type” attribute of “basketball” and a “color” attribute of red. A brand NFT can have a “brand” attribute that can be populated with the specific “brand” and these attributes can be obtained from the query. In some embodiments, cryptographic tokens to be input into a graphics generator can include any number of attributes, including attributes that describe the graphic to be generated directly (e.g., a color, a type of clothing, a size, etc.), and/or attributes that can be used to obtain information from a data source or third-party system to generate the graphic. For example, a unique identifier can be included as an attribute in a digital asset of a cryptographic token and can correlate to a catalogue item for a particular retailer (e.g., can correspond to a specific model of shoe from a particular shoe manufacturer). Any attribute obtained from a cryptographic token or digital asset associated with the token can be obtained, and a graphics generator may use different attributes based on the virtual environment in which the graphic is to be generated.

At block 710, a payload can be generated based on the metadata (e.g., the attributes) of the identified tokens. The payload can be a format that can be used to generate the graphic, or obtain information required to generate the graphic. For example, all or a portion of the metadata can be translated into a json format in a predefined data structure and provided via API to a third-party endpoint to obtain a result. For example, a retailer may provide an API endpoint for obtaining digital renderings of catalogue items based on a payload provided to the API. The metadata for a cryptographic token or asset thereof corresponding to a first model of a shoe from a retailer can be formatted to be compatible with the API, and in response to receiving the formatted data (e.g., in a PUT or POST call), the API can return a two or three-dimensional rendering of the specific model of the shoe. In other embodiments, all or a portion of the metadata can be integrated into a query for a database (e.g., an SQL query). In some embodiments, the data can be unstructured, or structured to be received into an artificial intelligence model.

At block 712, the graphic can be generated based on the payload. In some cases, this can include receiving graphics files via one or more API endpoints based on a payload provided to each. For example, a logo graphic can be obtained through an API call to a first endpoint, and a graphic shoe can be obtained in an API call to a second endpoint. The logo can be overlaid onto the shoe, to generate the graphic. In some cases, graphics can be combined according to rules of the system. For example, a graphic shoe can include areas on the shoe available for overlay, and the logo can be restricted to being overlaid in that area. In some embodiments, generating the graphic does not include interaction with a third-party service, and instead, the graphic generator generates the graphic based on the attributes provided. In some cases, all or a portion of the graphics generation can be performed using artificial intelligence models, the metadata can be input into the artificial intelligence model, and the artificial intelligence model can produce a unique graphic based on the metadata provided.

At block 714, the process 700 can render the graphic in a virtual environment. For example, in some cases, the graphics generator system is integrated with a video game, and the graphic is generated directly into the game. In other embodiments, the graphics generator system provides an API endpoint for receiving graphics generated thereby, and another system can query (e.g., issue an API call) the graphics generator system to receive a graphic for use within the virtual environment.

In some cases, cryptographic assets can represent contracts and brand agreements between the owner thereof and a given brand. For instance, a brand (e.g., a corporation) can virtually sponsor an individual in a video game, metaverse, or other virtual environment, and can transfer a digital asset to the individual representing this sponsorship. The ownership of a logo NFT can indicate a sponsorship agreement, and the logo NFT can include term attributes that can be used by a virtual environment to enforce one or more terms of the sponsorship or licensing agreement. For example, a video game participant may be sponsored by a first corporation, and the agreement can include an agreement to display a logo of the first corporation on a clothing item of a video game character controlled by the video game participant (e.g., a sports logo can be displayed on a virtual clothing item such as a shirt, pants, shoes, shorts, eyewear, headwear, gloves, etc.). The sponsorship can require that the logo be displayed by the user within the game for a certain proportion or amount of time that the video game participant is engaged in the video game. The agreement can further specify a display requirement including a size of the logo for example.

In this regard, a logo NFT can be provided to the user and be owned by the user in a virtual wallet of the user. A digital asset associated with the logo NFT can include attributes for a sponsorship agreement. For example, the NFT 592 shown in FIG. 6 can be a logo NFT, and the digital asset 572 associated with the logo NFT can include attributes “area” and “display_time.” The “area” can be defined as an area or ratio (e.g., 0.05 as shown) of a total spatial area occupied by a video game character controlled by the user, or by a virtual item of clothing worn by the video game character. The “time displayed” can be a ratio of the total time in which the video game character is displayed within the virtual environment and can define for what proportion of that time a logo of the corporation is to be displayed (0.4). Further, the logo NFT can include other attributes including agreement terms, including, for example a brand API endpoint attribute (e.g., the “brand_guidelines” attribute shown in FIG. 6) with a link at which a brand API can be accessed to obtain display parameters for a logo of a corporation, as described below. Attributes that can be associated with a logo NFT are not limited to the attributes described above, or illustrated in FIG. 6. Further, attributes can be assigned any name, and the names of attributes can be arbitrarily set to correspond to a particular brand, a particular virtual environment, a particular blockchain, or a particular digital item or class of digital items to be associated with the logo NFT.

The logo NFT 592 can be used in the process 700 described above and can be overlaid onto a clothing item associated with another NFT in a wallet of the user to be displayed in a virtual environment (e.g., the video game). In some examples, the logo NFT 592 and associated digital asset 572 can be accessed directly by the virtual environment without being first provided to a graphics generator system. For example, the virtual environment can obtain the digital asset associated with the logo NFT and can enforce the terms of the sponsorship agreement represented thereby, for example, by displaying a logo of the corporation for the specified amount of time or at the specified size. Display parameters of the logo displayed according to the terms represented in the digital asset of the logo NFT 592 can be dynamically updated within the virtual environment (e.g., the video game). For example, if a video game character controlled by a participant rotates so that a portion of a clothing item including the logo is no longer visible within the video game, the video game can dynamically reposition the logo on the virtual clothing of the video game character to ensure that the logo is visible to other participants or spectators of the video game for the proportion of time specified in the digital asset of the NFT.

In some examples, a brand sponsorship or licensing agreement can incorporate brand guidelines, which can specify a color scheme for branding (e.g., including a logo) of the brand, and further include other standards including a relative sizing of a logo, a version of a logo which can be used, a color scheme for items incorporating the logo, etc. Brand guidelines can dictate a font to be used when displaying the brand. For example, in some contexts, a brand or corporation may require that a trade name be displayed with a logo, and in other contexts, the corporation may require that the logo be displayed without the trade name. This information may be updated by a corporation at any interval, and thus, storing these parameters in a digital asset of a logo NFT may be disadvantageous, as a logo NFT representing a licensing or branding agreement may be immutable to preserve the terms agreed to by the user and the corporation. A logo NFT can thus include information referencing brand guidelines. As shown, the information includes the brand API endpoint 708. The brand API endpoint can be used by the virtual environment (e.g., the video game) to obtain color schemes, fonts, different logos for display in different contexts, etc., and the video game can use this branding information to generate graphics for branded items of the video game participant (e.g., a virtual clothing item, a virtual shoe, a skin, a virtual vehicle, etc.). For example, a virtual environment can enforce a color scheme for all or a portion of a virtual clothing item incorporating a brand logo, in accordance with the information received from the brand guidelines API.

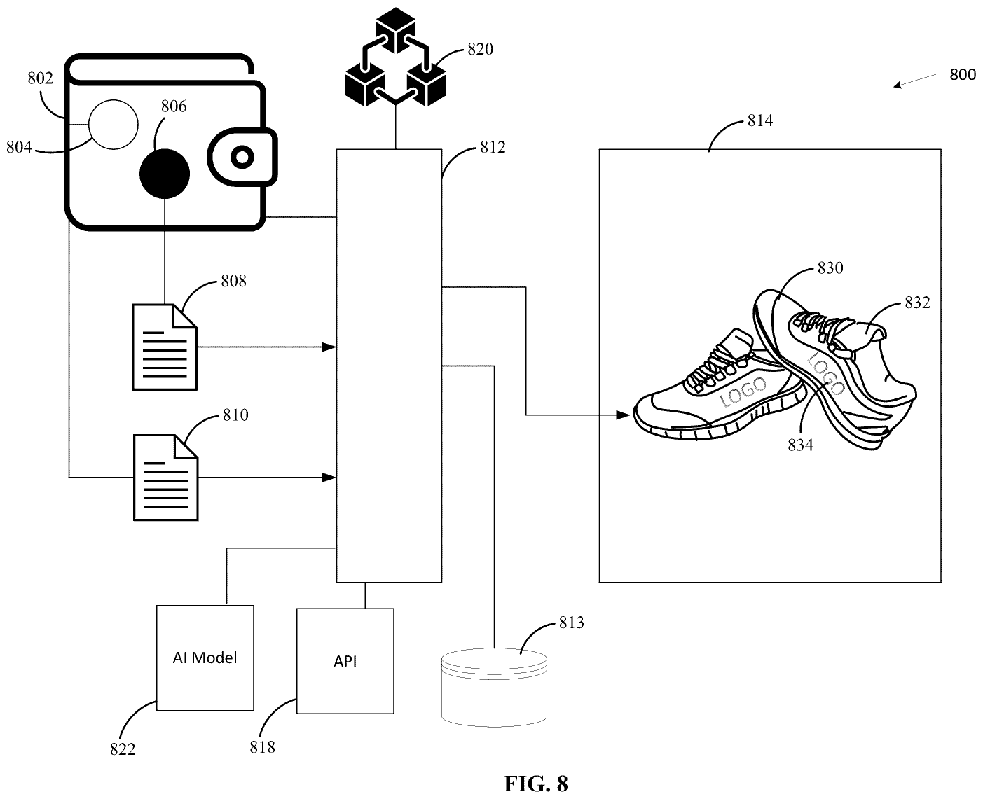

FIG. 8 illustrates an example system 800 for generating graphics for cryptographic tokens (e.g., using the process 700). As shown, the system 800 can include a digital wallet 802 for a user, which can include multiple cryptographic tokens 804, 806. For example, a first cryptographic token 804 can be a shoe NFT and can be linked to a digital shoe digital asset 808 including attributes of a digital shoe. A second cryptographic token 806 can be a logo NFT linked to a digital asset 810 including brand information and/or licensing and sponsorship attributes, as described above. The digital wallet 802 can be operatively linked to a graphics generator system 812 (e.g., as described in block 702).

As shown, the graphics generator system 812 can be operatively linked to the digital wallet 802 and a virtual environment 814 (e.g., a video game, a metaverse, an online community, a web site, etc.). The graphics generator system can be integral to a given virtual environment (e.g., it may be a module within the virtual environment) or can be a service that can be linked to multiple virtual environments and can provide graphics to different virtual environments. In some embodiments, a user wallet is first connected to a virtual environment and is operatively connected to the graphics generator system by virtue of its connection with the virtual environment.

A graphics generator system can receive information from digital assets associated with NFTs in a user wallet linked with the graphics generator system (e.g., as described at block 704 of process 700 shown in FIG. 7). For example, as shown, the graphics generator system 812 can receive data from digital assets 808, 810. In some embodiments, the data received from a digital asset can include an image of the digital asset. In some embodiments, only attributes of the digital asset are consumed by the graphics generator system for the purpose of generating graphics in a virtual environment.

In some embodiments, a graphics generator system can generate a graphic associated with one or more NFTs in a user wallet based only on attributes of the digital asset, according to set rules. For example, a graphics generator system can include a library of images (e.g., two-dimensional or three-dimensional images) and can assign an image based on an attribute of the one or more digital assets associated with NFTs in a user wallet. For example, if an “object_type” attribute of a digital asset is “shoe,” the graphics generator system can assign an image of a shoe, and if a “color” attribute is specified, the graphics generator can color the shoe the specified color. As shown, the graphics generator system 800 can be operatively connected with a database 813, which can contain preset images, digital skeletons of images, graphics for overlaying on images, etc.

In some embodiments, a graphics generator can generate graphics for NFTs in a user's digital wallet based on information not included in the digital assets or based on additional contextual information. For example, as shown, the graphics generator system 812 can communicate with one or more API endpoints 818 to receive additional information to inform graphics generation. For example, as described above, the API endpoint 818 can be a brand API, which can include graphics files for a logo, or information on styling or color schemes to be used in generating the graphic. In some embodiments, the API endpoint 818 can be a virtual catalogue from a corporation including a listing of digital products for the corporation, and the graphics generator module can obtain a particular digital product from the catalogue API based on the attributes of the digital assets 808, 810. In some embodiments, the API can provide information about events which can inform how a graphic is generated and/or displayed within a virtual environment. For example, a digital asset for an NFT can include attributes associating the NFT with a particular athlete, and a graphic can include a degree of radiance or dullness based on the performance of the particular athlete over a given course of time, as obtained from the API endpoint 818. A graphics generator system can consume any information from any API endpoint to inform how a graphic is generated and is not limited to the examples provided above. Additionally, the graphics generator system can be operatively connected to a blockchain network 820 (e.g., the blockchain hosting the NFTs 804, 806), and can consume event information from oracles hosted on the blockchain 820 to inform graphic generation (e.g., as described with respect to API endpoints 818).

As further shown, the graphics generator system 800 can integrate with artificial intelligence model 822 to generate graphics to be displayed in a virtual environment. The AI model 822 can be a model for producing virtual apparel or any other digital objects. In some cases, the specific digital object to be generated can be provided to the model 822, while in other embodiments, the model 822 can determine what to generate based on unstructured data provided to the model.

The graphics generator system 800 can generate a graphic 830 based on the inputs provided, including attributes of the digital assets 808, 810, and can render the graphic into the virtual environment 814. In the illustrated embodiment, the first digital 808 asset includes attributes of a shoe and the second digital asset 810 includes branding attributes, which can include a logo. Alternatively, the second digital asset 810 includes attributes to allow the graphics generator system 800 to obtain a logo or other brand elements from a third-party system (e.g., API endpoint 818). The graphics generator can generate a graphic of shoes 832 including a logo 834 and render the graphic into the virtual environment 814. In some embodiments, the graphics generator system can be used to generate graphics specific to a look and feel of the particular environment 814.

In some cases, generation of graphics, including for overlaying a logo onto a virtual item represented by an NFT, can be performed by breeding NFTs. For example, a user may own an NFT for a generic (e.g., an unbranded) item, and may desire to display a branded item within the context of a virtual environment. In some contexts, then, the user can breed an NFT representing an item (e.g., a virtual article of clothing, a virtual item of sports equipment, a virtual vehicle, etc.) with an NFT of a brand to obtain a branded item NFT. A digital asset associated with the branded item NFT can include a graphic of the branded item. In some cases, then, a user may obtain (e.g., may be given or may purchase) a brand NFT, and the brand NFT can entitle the user to breed one or more NFTs with the brand NFT to produce branded child NFTs which can be usable in one or more virtual environments. In some cases, a user can breed NFTs with a brand NFT in a wallet of the user to obtain branded child NFTs. In some cases, the brand NFT can be owned by another user or by a corporation and breeding the brand NFT can require participation (e.g., an approval) by the owner of the brand NFT. In some cases, a virtual contract used for breeding a brand NFT with another NFT can enforce a scarcity of the brand (e.g., a number of times brand NFT can be bred with another NFT can be limited).

In some cases, one or more of the NFTs used in the breeding process can be burned as part of the breeding process. In some cases, a brand NFT can be burned after having been bred a certain number of times. For example, a user can obtain a first brand NFT that can entitle them to display up to 5 digital objects with branding from a first corporation to be displayed in a virtual environment. NFTs associated with digital objects can be bred with the brand NFT to produce child NFTs including the branded object (e.g., in one or both of the attributes of the digital assets of the child NFTs or an image associated with the digital asset), and after producing 5 child NFTs, the first brand NFT can be burned.

In some cases, a breeding process can ensure that displayed images meet brand guidelines. For example, a smart contract used to execute the breeding process between a brand NFT and an NFT associated with a digital object can require that the digital object does not include any other branding before the associated NFT can be bred with the brand NFT. In another embodiment, logos or branding associated with other corporations can be removed in a breeding process so that a child NFT includes only branding associated with the brand NFT. Further, a breeding process and the smart contract enacting it can enforce brand guidelines for other visual elements of a digital object of the child NFT including placement of branding on a child digital object, spacing from other objects or text on the digital object, a font or color scheme used in the digital object, etc.

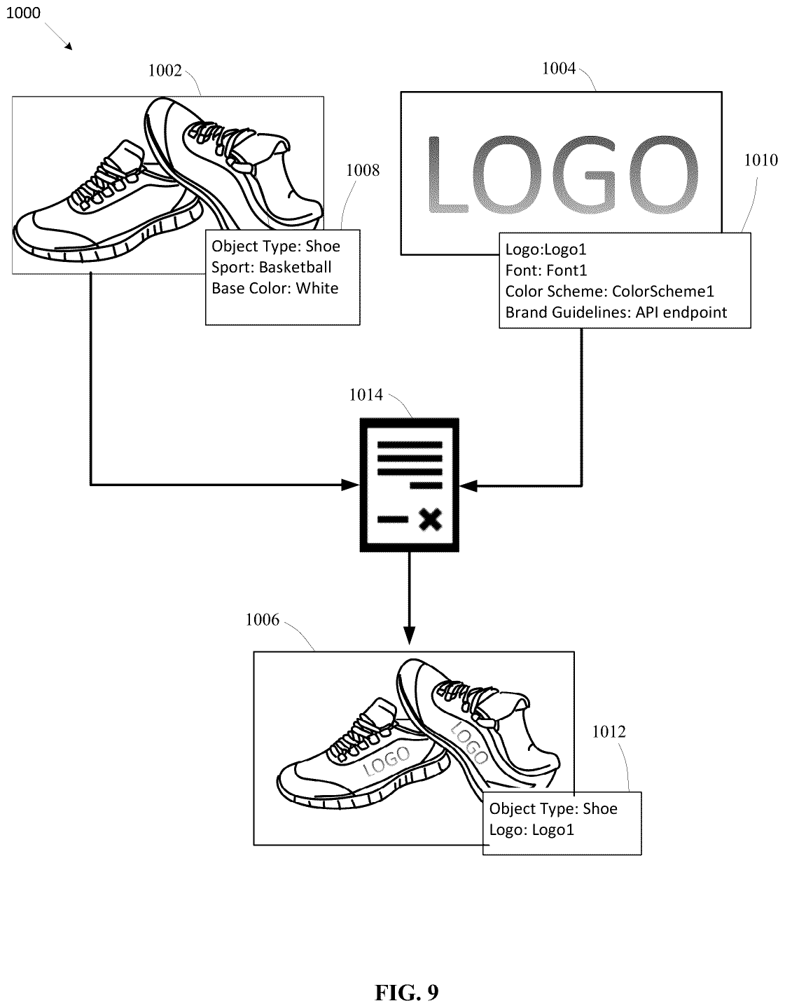

For example, FIG. 9 illustrates an example of a breeding process 1000 in which a first parent NFT 1002 and a second parent NFT 1004 are bred to produce a child NFT 1006. The first parent NFT 1002 is associated with a first digital asset 1008 representative of a digital object, the second parent NFT 1004 is associated with a second digital asset 1010 representative of a brand, and the child NFT 1006 is associated with a child digital asset 1012. In the illustrated embodiment, each of the digital assets 1008, 1010 includes attributes describing a digital shoe, including an “Object Type” of “shoe,” a “Sport” of “Running,” and a “Base Color” of “White.” Digital assets according to the teachings of this disclosure can have any attribute and any number of attributes, and the attributes illustrated here are for the purpose of illustration and are not intended to be limiting. As shown, the second digital asset 1010 (i.e., the brand digital asset) includes attributes of a brand, which as shown, include a “Logo” of “Logo1,” a “Font” of “Font1,” a “Color Scheme” of “ColorScheme1,” and a “Brand Guidelines” as “API endpoint.” The attributes of a brand digital asset for a brand NFT can thus describe elements of the brand, which can be used to generate a graphic or graphic description for a digital object for a child NFT. A child NFT and associated digital object can inherit attributes of digital objects associated with each parent NFT and can include a different set of attributes than those of the parent NFT. As shown, attributes of the child digital asset 1012 include an “Object Type” of “Shoe” inherited from the first parent digital asset 1008, and a “Logo” of “Logo1,” inherited from the second parent digital asset 1010. In other embodiments, NFTs used in breeding can have any number of attributes. Further, in other embodiments, more than two parent NFTs can be combined or bred to produce a child NFT. In some embodiments, a breeding operation can combine elements of attributes from parent NFTs to produce a new attribute for the child NFT. In some embodiments, one or more parent NFTs can be burned to breed a child NFT.

Smart contracts can be provided to govern the terms of breeding operations for NFTs. For example, as shown in FIG. 9, the parent NFTs 1002, 1004 are provided to a smart contract 1014 to produce the child NFT 1006. The smart contract 1014 can define rules for combining NFTs, and for aggregating attributes of digital assets associated therewith. For example, the smart contract 1014 can enforce brand guidelines for a generated child NFT, as described above. The brand guidelines can dictate that branding be displayed on any graphics associated with the child NFT in a certain size, shape, location, etc. FIG. 9, for example, illustrates a graphic generated for child NFT 1006 as part of execution of the smart contract 1014, which as shown, overlays the logo associated with brand NFT 1004 onto the digital shoes associated with digital asset 1002. As described above, the smart contract 1014 can require that one, both, or neither of the parent NFTs 1002, 1004 be burned to generate the child NFT 1006. Graphics associated with the child NFT 1006 (e.g., a graphic referenced in the digital asset 1012 of the NFT 1006 or generated based on the attributes of NFT 1006 according to the process 700) can be displayed in a virtual environment.

The above-described aspects of the processes of FIGS. 5 and 7 can be executed or performed in any order or sequence not limited to the order and sequence shown and described in the figures. Also, some of the above aspects of the processes of FIGS. 5 and 7 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A method of generating graphics for digital assets, comprising:
receiving an input identifying a first digital wallet;
identifying one or more non-fungible tokens associated with the first digital wallet;
determining which of the one or more non-fungible tokens are compatible with a virtual environment;
selecting, from the compatible one or more non-fungible tokens, at least one non-fungible token, each token of the selected at least one non-fungible token being associated with a corresponding digital asset including at least one attribute;
generating, based on at least one attribute of the digital assets corresponding to each token of the selected at least one non-fungible token, a graphic;
providing the graphic to the virtual environment; and
displaying the graphic within the virtual environment.

2. The method of claim 1, wherein generating the graphic includes providing the at least one attribute of the digital assets corresponding to each token of the selected at least one non-fungible token to a trained artificial intelligence model.

3. The method of claim 1, wherein the graphic is generated based on data received from an application programming interface.

4. The method of claim 1, wherein at least one of the one or more non-fungible tokens is associated with a brand digital asset including brand guidelines, and wherein the graphic is generated based on the brand guidelines.

5. The method of claim 4, wherein the brand guidelines include a logo, and wherein the logo is included in the graphic.

6. The method of claim 4, wherein an API endpoint is included as an attribute of the brand guidelines.

7. The method of claim 5, wherein the graphic includes a logo, and wherein a total display time of the logo in the virtual environment is based, at least in part, on a timing attribute of at least one digital object corresponding to the selected at least one non-fungible token.

8. The method of claim 1, wherein the graphic is not based on graphics associated with the digital assets corresponding to the selected at least one non-fungible token.

9. The method of claim 1, wherein the selected at least one non-fungible token includes a sponsorship non-fungible token associated with a sponsorship digital asset, wherein at least one attribute of the sponsorship digital asset is associated with a term of a sponsorship agreement.

10. A method of generating non-fungible tokens, including:
retrieving, from a first blockchain, a first token and a second token that are compatible with a first virtual environment and that are associated with a first digital wallet, the first token being associated with a first digital asset defining a first attribute and the second token being associated with a second digital asset defining a second attribute;
providing the first and second tokens to a first smart contract;
generating, by the first smart contract, based at least on the first attribute and the second attribute, a third token and a third digital asset associated with the third token, the third digital asset including at least one display attribute;
generating, based on the at least one display attribute, a graphic; and
displaying the graphic within the first virtual environment.

11. The method of claim 10, wherein generating the third token includes burning the first token.

12. The method of claim 10, wherein the graphic is generated based on information received from a third-party source.

13. The method of claim 10, wherein the graphic includes a logo.

14. The method of claim 13, wherein the at least one display attribute includes a size attribute for the logo.
